(19) United States
(12) Patent Application Publication
(10) Pub. No.: US 2009/0243250 A1
(43) Pub. Date: Oct. 1, 2009

(54) BICYCLE SPROCKET ASSEMBLY

(75) Inventor: Douglas Chiang, Taichung City (TW)

Correspondence Address: Chien-Hui Su, P. O. Box 70-121 Taichung, Taichung City, 40899, TW

(73) Assignee: TIEN HSIN INDUSTRIES CO., LTD., Taichung City (TW)

(21) Appl. No.: 12/057,393

(22) Filed: Mar. 28, 2008

(51) Int. Cl. B62M 1/02

(52) U.S. Cl. 280/260

(57) ABSTRACT

A bicycle sprocket assembly comprises a first sprocket unit formed in one piece, a second sprocket unit formed in one piece and being hollow inside, and a third sprocket unit formed in one piece. The first sprocket unit includes at least one sprocket and a first protrusion. The second sprocket unit includes at least two sprockets with different outer diameter, a first recess formed in a side of the larger outer diameter sprocket and a second recess formed in a side of the smaller outer diameter sprocket. The third sprocket unit includes at least one sprocket and a second protrusion. In assembly, the first protrusion of the first sprocket unit engages with the first recess of the second sprocket unit and the second protrusion of the third sprocket unit engages with the second recess of the second sprocket unit.

### FIELD OF THE INVENTION

The present invention relates to a bicycle sprocket assembly of a bicycle rear wheel, and particularly to a lightweight and high strength sprocket assembly, wherein the sprocket assembly can be installed or detached from the rear wheel easily and quickly.

### BACKGROUND OF THE INVENTION

Referring to U.S. Pat. No. 7,131,656, “sprocket support member for a bicycle sprocket assembly” is disclosed, in that a bicycle sprocket assembly is provided, which includes at least one subassembly including a sprocket support member and two sprockets. The support member has at least one engagement portion for coupling it to a bicycle freewheel and at least one fastening portion arranged in a radially external position with respect to the engagement portion. Both sprockets are fixed on the sprocket support member on the same side of the fastening portion.

Above mentioned structure provides a support member for fastening two sprockets, it still has some drawbacks. First, the bicycle sprocket assembly normally includes nine or ten sprockets; it takes time to fasten the sprockets in pairs and then install them. Of course when the sprocket is needed to be replaced, the detaching process is time-consuming and complicated. Second, the parts of the sprocket assembly are so numerous and complicated that the manufacturing cost is high. Third, the larger outer diameter sprocket will sustain higher torque than the smaller outer diameter sprocket. How to reduce stress concentration and improve the strength of the larger outer diameter sprocket is an eager problem to overcome. Additionally, how to reduce the weight is another issue.

### SUMMARY OF THE INVENTION

Accordingly, the primary object of the present invention is to provide a bicycle sprocket assembly, wherein the structure is simple so that the rider and user can install or detach the sprocket assembly easily and quickly. Furthermore high strength and weight-reducing structure is provided.

To achieve above objects, the present invention provides a bicycle sprocket assembly, comprising: a first sprocket unit formed in one piece, the first sprocket unit having at least one sprocket, the first sprocket unit having a engagement portion for engaging with a bicycle freewheel hub and a first protrusion; a second sprocket unit formed in one piece and being hollow inside, the second sprocket unit having at least two sprockets with different outer diameter, an outer diameter of each sprocket of the second sprocket unit being smaller than an outer diameter of the sprocket of the first sprocket unit, a first recess formed in a side of the larger outer diameter sprocket of the second sprocket unit for engaging with the first protrusion of the first sprocket unit, a engagement portion for engaging with the bicycle freewheel hub and a second recess formed in a side of the smaller outer diameter sprocket of the second sprocket unit; and a third sprocket unit formed in one piece, the third sprocket unit having at least one sprocket, an outer diameter of the sprocket of the third sprocket unit being smaller than the outer diameter of each sprocket of the second sprocket unit, the third sprocket unit having a engagement portion for engaging with the bicycle freewheel hub and a second protrusion for engaging with the second recess of the second sprocket unit.

The various objects and advantages of the present invention will be more readily understood from the following detailed description when read in conjunction with the appended drawing.

### BRIEF DESCRIPTION OF THE DRAWINGS

FIG. 1 is an exploding view of a bicycle sprocket assembly of the present invention.

FIG. 1A is another perspective view of the second sprocket unit of the present invention.

FIG. 2 is a front view of the second sprocket unit of the present invention.

FIG. 3 is a rear view of the third sprocket unit of the present invention.

FIG. 4 is a front view of the first sprocket unit of the present invention.

FIG. 5 is a rear view of the second sprocket unit of the present invention.

FIG. 6 is a side cross-sectional view of the bicycle sprocket assembly of the present invention.

FIG. 7 is a perspective view of the second sprocket unit of the bicycle sprocket assembly according to the second embodiment of the present invention

FIG. 8 is a side cross-sectional view of the bicycle sprocket assembly according to the second embodiment of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

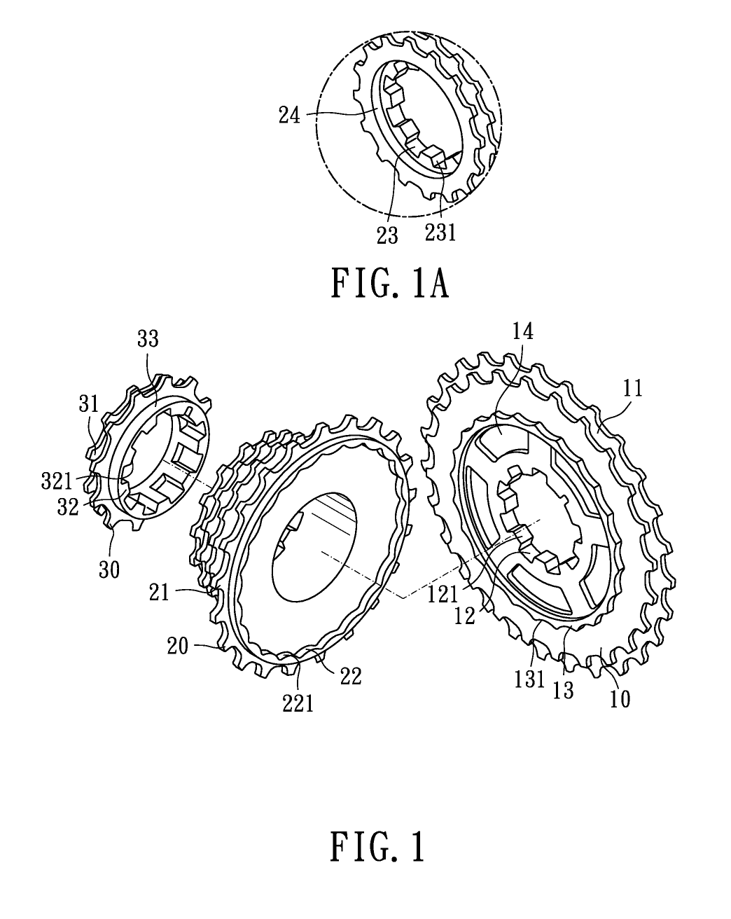

With reference to FIGS. 1 to 6, a bicycle sprocket assembly of the present invention is illustrated. The bicycle sprocket assembly includes a first sprocket unit 10, a second sprocket unit 20, and a third sprocket unit 30.

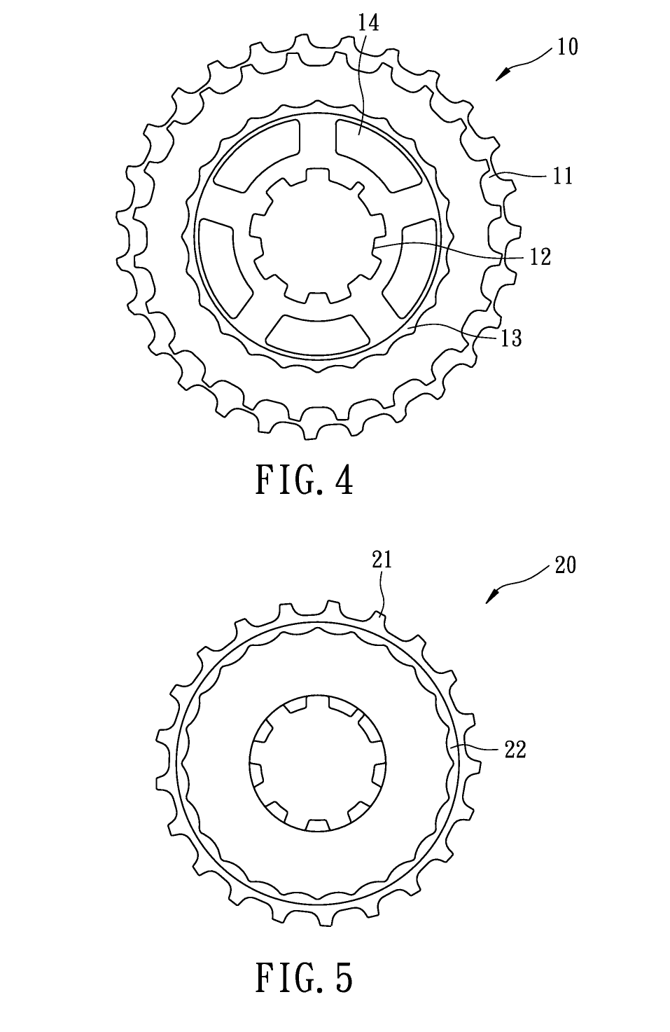

Referring to FIG. 1 and FIG. 4, the first sprocket unit 10 is formed in one piece and has two sprockets 11 with different outer diameter. An engagement portion 12 penetrates through the center of first sprocket unit 10 and is formed by a plurality of teeth 121 for engaging with a bicycle freewheel hub. A first protrusion 13 forms in a side of the smaller outer diameter sprocket 11 and is formed by a plurality of teeth 131. A shape of the teeth 131 of the first protrusion 13 is spline or polygon. The first sprocket unit 10 includes a plurality of hollow portion 14 and is made of titanium or aluminum for reducing the weight.

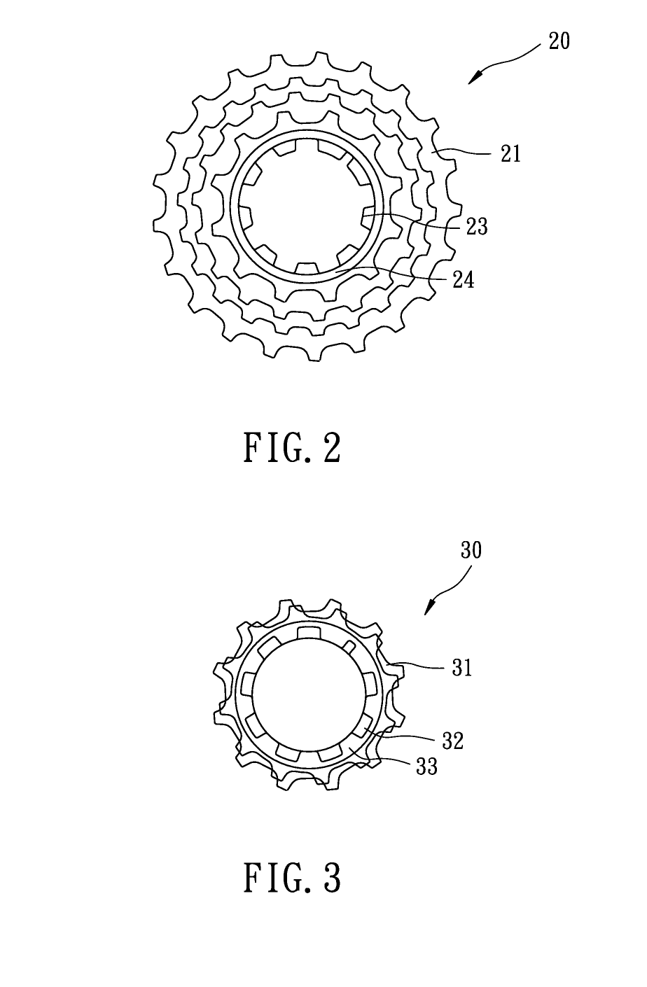

Referring to FIG. 1, FIG. 1A, FIG. 2, and FIG. 5, the second sprocket unit 20 is formed in one piece and has four sprockets 21 with different outer diameter. In other embodiment the number of sprocket 21 can be up to six. The outer diameter of each sprocket 21 of the second sprocket unit 20 is smaller than the outer diameter of each sprocket 11 of the first sprocket unit 10. A first recess 22 forms in a side of the larger outer diameter sprocket 21 and is formed by a plurality of teeth 221 for engaging with the first protrusion 13 of the first sprocket unit 10. A shape of the teeth 221 of the first recess 22 is spline or polygon corresponding to the shape of the teeth 131 of the first protrusion 13. An engagement portion 23 penetrates through the center of second sprocket unit 20 and is formed by a plurality of teeth 231 for engaging with the bicycle freewheel hub. A second recess 24 forms in a side of the smaller outer diameter sprocket 21 and is in a shape of circular. The second sprocket unit 20 can be hollow inside for reducing the weight.

Referring to FIG. 1 and FIG. 3, the third sprocket unit 30 is formed in one piece and has two sprockets 31 with different outer diameter. The outer diameter of each sprocket 31 of the third sprocket unit 30 is smaller than the outer diameter of each sprocket 21 of the second sprocket unit 20. An engagement portion 32 penetrates through the center of third sprocket unit 30 and is formed by a plurality of teeth 321 for engaging with the bicycle freewheel hub. A second protrusion 33 forms in a side of the larger outer diameter sprocket 31 and is in a shape corresponding to the shape of the second recess 24 for engaging with the second recess 24 of the second sprocket unit 20.

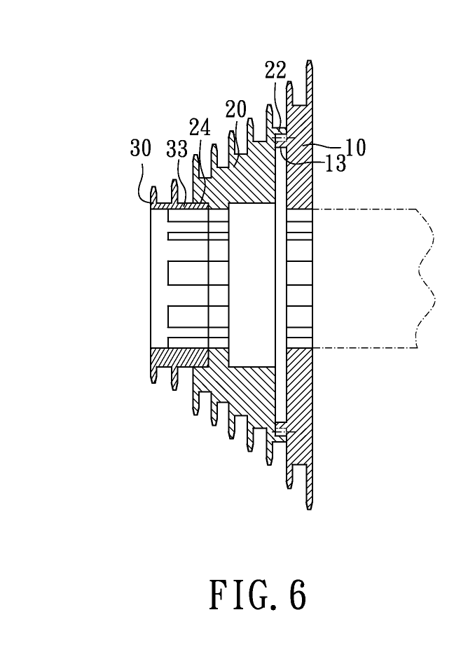

Referring to FIG. 6, the first protrusion 13 engages with the first recess 22 and the second protrusion 33 engages with the second recess 24, so the first sprocket unit 10, the second sprocket unit 20, and the third sprocket unit 30 are assembled together easily and quickly. The first protrusion 13 and the second protrusion 33 also provide the spacing function to place those sprocket units in the right position.

Due to the first protrusion 13 engages with the first recess 22, the torque in the larger sprocket 11 of the first sprocket unit 10 will be distributed to the second sprocket unit 20. The distribution of the stress will be more uniform. Moreover the first sprocket unit 10, the second sprocket unit 20, and the third sprocket unit 30 are formed in one piece respective. The strength of the sprocket assembly will be higher than the prior art.

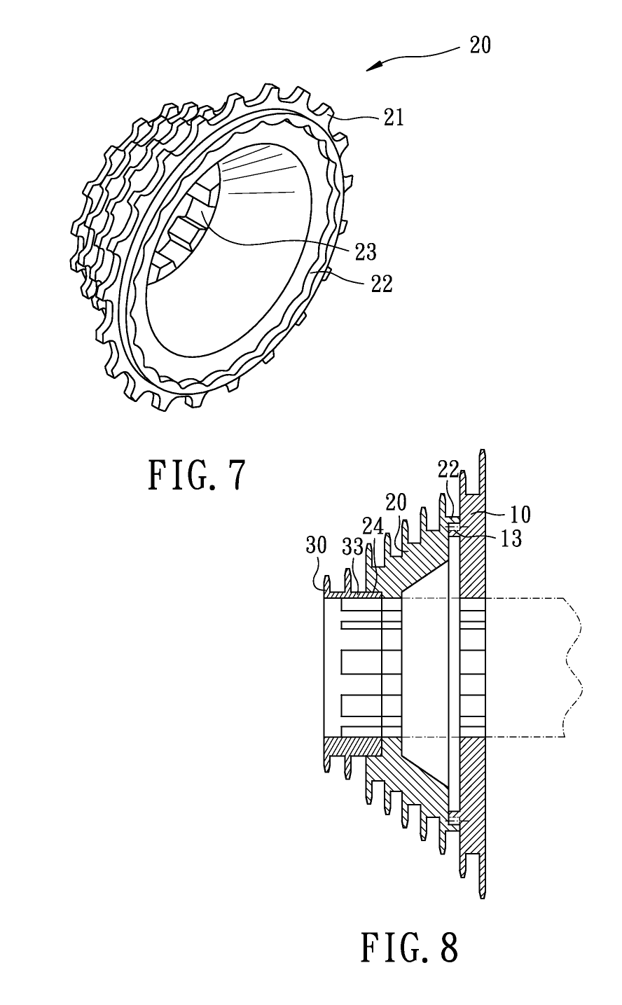

Referring to FIG. 7 and FIG. 8, the second embodiment of the present invention is shown. The second sprocket unit 20 is taper and hollow inside to reduce more weight. Furthermore the engagement portion 23 forms merely in the side of the smaller outer diameter sprocket 21 without affecting the transmission. It will save more cost and reduce more weight.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A bicycle sprocket assembly, comprising:
a first sprocket unit formed in one piece, the first sprocket unit having at least one sprocket, the first sprocket unit having a engagement portion for engaging with a bicycle freewheel hub and a first protrusion; and
a second sprocket unit formed in one piece, the second sprocket unit having at least two sprockets with different outer diameter, an outer diameter of each sprocket of the second sprocket unit being smaller than an outer diameter of the sprocket of the first sprocket unit, a first recess formed in a side of the larger outer diameter sprocket of the second sprocket unit for engaging with the first protrusion of the first sprocket unit, a engagement portion formed in a side of the smaller outer diameter sprocket of the second sprocket unit for engaging with the bicycle freewheel hub.

2. The bicycle sprocket assembly as claimed in claim 1, wherein the second sprocket unit is hollow.

3. The bicycle sprocket assembly as claimed in claim 1, further comprising a third sprocket unit formed in one piece, the third sprocket unit having at least one sprocket, an outer diameter of the sprocket of the third sprocket unit being smaller than the outer diameter of each sprocket of the second sprocket unit, the third sprocket unit having a engagement portion for engaging with the bicycle freewheel hub and a second protrusion, a second recess formed in the side of the smaller outer diameter sprocket of the second sprocket unit for engaging with the second protrusion of the third sprocket unit.

4. The bicycle sprocket assembly as claimed in claim 1, wherein the first sprocket unit includes a plurality of hollow portion.

5. The bicycle sprocket assembly as claimed in claim 1, wherein the first sprocket unit is made of titanium or aluminum.

6. The bicycle sprocket assembly as claimed in claim 1, wherein the first protrusion has a shape of a plurality of teeth, the first recess has a shape of a plurality of teeth corresponding to the shape of the teeth of the first protrusion.

7. The bicycle sprocket assembly as claimed in claim 1, wherein the shape of the teeth of the first protrusion and the first recess is spline or polygon.

8. A bicycle sprocket assembly, comprising:
a first sprocket unit formed in one piece, the first sprocket unit having at least one sprocket, the first sprocket unit having a engagement portion for engaging with a bicycle freewheel hub and a first protrusion;
a second sprocket unit formed in one piece and being hollow inside, the second sprocket unit having at least two sprockets with different outer diameter, an outer diameter of each sprocket of the second sprocket unit being smaller than an outer diameter of the sprocket of the first sprocket unit, a first recess formed in a side of the larger outer diameter sprocket of the second sprocket unit for engaging with the first protrusion of the first sprocket unit, a engagement portion for engaging with the bicycle freewheel hub and a second recess formed in a side of the smaller outer diameter sprocket of the second sprocket unit; and
a third sprocket unit formed in one piece, the third sprocket unit having at least one sprocket, an outer diameter of the sprocket of the third sprocket unit being smaller than the outer diameter of each sprocket of the second sprocket unit, the third sprocket unit having a engagement portion for engaging with the bicycle freewheel hub and a second protrusion for engaging with the second recess of the second sprocket unit.

9. The bicycle sprocket assembly as claimed in claim 8, wherein the first sprocket unit includes a plurality of hollow portion.

10. The bicycle sprocket assembly as claimed in claim 8, wherein the first sprocket unit is made of titanium or aluminum.

11. The bicycle sprocket assembly as claimed in claim 8, wherein the first protrusion has a shape of a plurality of teeth, the first recess has a shape of a plurality of teeth corresponding to the shape of the teeth of the first protrusion.

12. The bicycle sprocket assembly as claimed in claim 8, wherein the shape of the teeth of the first protrusion and the first recess is spline or polygon.
